(19) United States
(12) Patent Application Publication
(10) Pub. No.: US 2021/0057778 A1
(43) Pub. Date: Feb. 25, 2021

(54) Electrolyte Solution of Lead-Crystal Storage Battery, Preparation Method Thereof, and Lead-Crystal Storage Battery

(71) Applicant: ZHEJIANG THE LIGHT OF HEAVEN-EARTH BATTERY MANUFACTURING CO., LTD., Huzhou City (CN)

(72) Inventor: Jianmin Chen, Huzhou City (CN)

(21) Appl. No.: 16/544,399

(22) Filed: Aug. 19, 2019

(51) Int. Cl. H01M 10/0568; H01M 4/56; H01M 4/16

(52) U.S. Cl. CPC H01M 10/0568; H01M 4/16; H01M 4/56

(57) ABSTRACT

The present disclosure provides an electrolyte solution of a lead-crystal storage battery, a preparation method thereof, and a lead-crystal storage battery. The electrolyte solution comprises silica sol and precipitated silica in a mass ratio of 1:(0.005 to 0.05); a total content of silica in the electrolyte solution is from 1% to 4% as per a net content of the silica; the electrolyte solution further comprises 0.1% to 2% of lithium hydroxide based on a total amount of the electrolyte solution. Upon the completion of a formation step of the battery, the electrolyte solution changes from a flow dynamic state to a solidified electrolyte solution containing crystal particles. By using specific gelling agents in combination and adding a relatively large amount of lithium hydroxide in the electrolyte solution to facilitate the electrolyte solution becoming a solidified electrolyte solution containing crystal particles after a charge-discharge cycle, the present disclosure can have active materials of the electrode plates fixed firmly, and enhance the deep cycle capacity of the battery; a porous structure further provides enough space for ion motion to extend battery service life and improve low temperature performance and charge retention.

### TECHNICAL FIELD

The present disclosure belongs to the field of the storage battery, and more specifically, the present disclosure relates to a lead-crystal storage battery.

### BACKGROUND

The battery industry is a significant part of the new energy field, and has become a new hotspot in the development of global economy at present. The lead-acid storage battery is closely bound up with the power, transportation and information industries, and is inseparable from all domains of national economy including national defense, computers, scientific researches, ports, etc. From the point of view of sales revenue, lead-acid batteries currently account for 80% or more of the total revenue in the entire field of chemical power sources. Domestic lead-acid battery industry has developed rapidly, and large-scale enterprises have reached a considerable scale of production and a very high technological level. With the increasing international market demand, China has become one of the largest exporters of lead-acid storage batteries.

A lead-acid storage battery is a flooded battery that is filled with a large amount of liquid flowable electrolyte solution, which causes inconvenient transportation, and is easy to precipitate acid mist that is harmful to the environment. With the development of the communication industry, lead-acid storage batteries are required to be large in specific energy, convenient in maintenance, free of pollution and so on. Then, valve regulated lead acid (VRLA) batteries have been produced following after flooded batteries. The batteries are designed as starved-electrolyte solution batteries by using an aqueous solution of sulfuric acid as the electrolyte solution, and storing a majority of the electrolyte solution in an absorbent glass mat (AGM) and a minority of the electrolyte solution in pores of the active materials of the positive and negative electrode plates, so that the battery case is substantially free of flowable electrolyte solution, so it is called a starved-electrolyte solution battery (referred to as an “AGM-VRLA storage battery”). However, in practical use, the starved-electrolyte solution design causes issues, e.g., serious water loss of the electrolyte solution, incident acid stratification at the bottom of the battery and incident thermal runaway when the battery is recharged after deep discharge, etc.

Meanwhile, researches on gel storage batteries (referred to as “GEL-VRLA batteries”) upsurge in Europe. GEL-VRLA batteries can precisely solve the problem about starved-electrolyte solution of AGM-VRLA batteries. By adding sodium silicate as a gelling agent, earlier gel batteries form a three-dimensional network structure with sulfuric acid and water wrapped therein. The electrolyte solution is solid when it is stationary. When suffering from a certain shear force, the three-dimensional network structure of most gel storage batteries disintegrates rapidly, and the gel electrolyte solution is in the form of an aqueous solution. However, when the shear force is stopped, the gel electrolyte solution stands still and returns to the previous solid state. This thixotropy endows gel lead-acid storage batteries with the advantages of convenient transportation and barely leaking. Moreover, due to the immobilization of the gel itself, there is almost no stratification phenomenon of the electrolyte solution inside the gel batteries. With the starved-electrolyte solution design, the gel battery has better recovery from deep discharge, which can effectively prevent the gel electrolyte solution from drying out. Nonetheless, since the sodium silicate electrolyte is easily dehydrated and hardened in use, the capacity and life of the battery are not satisfactory. Later, the German Sonnenschein Corporation used hydrophilic fumed silica as a gelling agent to develop a commercial gel sealed lead-acid storage battery with improved battery performance. Because of strong gel strength and high surface activity of fumed silica, most of foreign large-scale companies manufacturing lead-acid storage batteries now utilize fumed silica as a gelling agent. However, in China, fumed silica is mainly imported, which leads to excessive raw material cost, and the viscosity of the glue liquid in fumed silica is too high and high technical requirements for potting are thus required. Due to blockade on the foreign technology, most of the domestically developed gel batteries are now hard to be potted; the positive active material is liable to softening and shedding; the gel batteries have high internal resistance, short life, and the like. The overall battery performance is still poor.

To cope with the above issues of gel batteries, Patent Literature 1 discloses adding a macromolecular stabilizing agent and a hydrophilic superfine glass fibre to set up a strong network structure together with sulfuric acid and water, so as to prevent gel electrolyte from being hydrated and to increase cycle life. Patent Literature 2 discloses adding fumed silica and then a small amount of precipitated silica to produce gel electrolyte solution to improve mobility of glue liquid and enhance stability. Nevertheless, both of Patent Literatures 1 and 2 have mainly used fumed silica as a gelling agent, which costs much, and since the resulting product is a gel battery, there still remain issues that the positive active material is liable to softening and shedding, the gel batteries have high internal resistance, etc. In recent years, a solid electrolyte concept is raised in China. Both Patent Literatures 3 and 4 disclose an electrolyte solution for manufacturing a lead crystal or microcrystal storage battery, in which nanoscale fumed silica is used as a gelling agent, the structure is emulsified and then magnetized to obtain a slightly acidic electrolyte solution, and after formation, the electrolyte solution becomes a crystal state to stop softening and shedding of the positive active material and extend the service life of the battery. Nevertheless, the above-mentioned literatures still have deficiencies of high cost, sophisticated process, instable properties of electrolyte, low capacity of battery, and the like.

In order to handle the above issues, the present inventors utilize a high-conductive silicate electrolyte, in lieu of fumed silica, as a gelling agent, which greatly reduces production cost, and prepares a leakage-free lead-crystal storage battery with long life. The earlier Patent Literature 5 of the present inventors discloses an environment-friendly and maintenance-free silicon crystal electrolyte and its preparation method, wherein the electrolyte contains sodium silicate as a gelling agent and is added with organic and inorganic additives, so that the content of sulfuric acid participating in the reaction is substantially decreased, fine silicon particles increase the surface pressure of the plate, reduce the internal resistance of the battery and increase heavy current and high and low temperature performance of the battery, while suppressing softening and shedding of the active material on the positive electrode plate, and the battery is cured by charging to form a solid battery without liquid leakage. Patent Literature 6 discloses a formula for the positive and negative electrode plates of the lead-crystal storage battery and a formula for electrolyte. Nonetheless, the technique disclosed in the above literature is very strict with the formation of fine silicon particles, because a slight change in amount of a component or a change in separator or battery assembly method tends to result in difficulty in potting, insufficient potting amount, or incomplete curing, so the technique is still improvable.

Patent Literature 1: CN101291002B

Patent Literature 2: CN102412421B

Patent Literature 3: CN103456999A

Patent Literature 4: CN106207279A

Patent Literature 5: CN100382376C

Patent Literature 6: CN106252746A

### SUMMARY

In one aspect, in general, the present disclosure describes techniques to provide an electrolyte solution for use in the preparation of a lead-crystal storage battery having good low temperature performance, strong recovery from deep discharge, high charge retention and reduced production cost, and a lead-crystal battery produced by the electrolyte solution.

The inventors of the present disclosure have conducted an intensive study on the gelling agent and additives of the electrolyte solution and have achieved a solidified electrolyte solution containing crystal particles, and the battery prepared by using this electrolyte solution has an improved electrical performance (in particular, low temperature performance, recovery from deep discharge and charge retention).

In another aspect, in general, the present disclosure describes an electrolyte solution of a lead-crystal storage battery, wherein the electrolyte solution comprises sulfuric acid, a gelling agent and lithium hydroxide; the gelling agent comprises silica sol and precipitated silica in a mass ratio of 1:(0.005 to 0.05); a total content of the silica in the electrolyte solution is from 1% to 4% as per the net content of the silica; a content of lithium hydroxide is from 0.1% to 2% based on a total mass of the electrolyte solution; after the completion of a formation step of the battery filled with the electrolyte solution, the electrolyte solution changes from a flow dynamic state to a solidified electrolyte solution containing crystal particles.

In another aspect, in general, the present disclosure describes a method of preparing the electrolyte solution, comprising: adding lithium hydroxide and other auxiliary materials to a sulfuric acid solution; and adding silica sol and precipitated silica to the solution, and then stirring the solution at 700 to 1500 r/min for 50 to 70 min.

In another aspect, in general, the present disclosure describes a lead-crystal storage battery, comprising: a battery container, the electrolyte solution or the electrolyte solution prepared by the above method, positive and negative electrode plates, and a separator.

Aspects may have one or more of the following advantages. By using specific gelling agents in combination and adding a relatively large amount of lithium hydroxide in the electrolyte solution to facilitate the electrolyte solution becoming a solidified electrolyte solution containing crystal particles after a charge-discharge cycle, the present disclosure can have active materials of the electrode plates fixed firmly, delay softening and shedding of the electrode plates, and enhance the deep cycle capacity of the battery; a porous structure further provides enough space for ion motion to efficiently reduce resistance, increase conductivity and oxygen recombination efficiency, increase capacity of the battery, extend battery service life, and improve low temperature performance and charge retention.

### BRIEF DESCRIPTION OF THE DRAWINGS

FIG. 1 is a picture of appearance of a solidified electrolyte solution formed after the formation of a lead-crystal storage battery obtained in an Example of the present disclosure.

FIG. 2 is an X-ray diffraction (XRD) spectrum of a solidified electrolyte solution formed after the formation of a lead-crystal storage battery obtained in an Example of the present disclosure.

FIG. 3 is an X-ray diffraction (XRD) spectrum of a dried and powered electrolyte solution in a solidified state, which is formed after the formation of a lead-crystal storage battery obtained in an Example of the present disclosure.

FIG. 4 is a picture of appearance of a gel electrolyte solution formed after the formation of GEL-VRLA storage battery in the prior art.

FIG. 5 is an X-ray diffraction (XRD) spectrum of a dried and powered gel electrolyte solution formed after the formation of GEL-VRLA storage battery in the prior art.

### DETAILED DESCRIPTION

Embodiments of the present disclosure will be described below, but the present disclosure is not limited thereto. The present disclosure is not limited to various configurations described below, and various modifications may be made within the scope sought to be protected by this disclosure. Besides, embodiments and examples formed by appropriately combining the technical means disclosed in the different embodiments and different examples are also included in the technical scope of the present disclosure. In addition, all of the literatures described in this specification are incorporated herein by reference.

It must be noted that as used herein and in the appended claims, the singular forms “a”, “an”, and “the” include plural referents unless the context clearly dictates otherwise.

The term “comprising” or “comprises” and any variants thereof used in the description, claims and the above-mentioned drawings of the disclosure is intended to cover non-exclusive inclusion. For example, a process, method or system, product or apparatus comprising a series of steps or units is not limited to the listed steps or units but optionally may further comprise steps or units that are not listed, or optionally further comprises other steps or units inherent to said process, method, product or apparatus.

The term “about” when used before a numerical designation, e.g., temperature, time, amount, and concentration, including range, indicates approximations which may vary by (+) or (−) 10%, 5% or 1%.

In the present disclosure, the term “formation” refers to electrolysis of electrode plates in an appropriate electrolyte solution to endow a positive plate and a negative electrode plate with polarity, respectively. For example, in a lead storage battery, a dried filler plate is electrolyzed in a dilute sulfuric acid, and under oxidation and reduction, lead oxide in the positive electrode plate becomes lead dioxide and lead oxide in the negative electrode plate becomes spongy lead. The term “after formation” in this specification refers to a situation after an available (capable of discharging) state is formed, and as a product, it does not concern about whether or not to be used.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

<Electrolyte Solution>

The present disclosure provides an electrolyte solution of a lead-crystal storage battery, wherein the electrolyte solution comprises sulfuric acid, a gelling agent and lithium hydroxide; the gelling agent comprises silica sol and precipitated silica in a mass ratio of 1:(0.005 to 0.05); a total content of the silica in the electrolyte solution is from 1% to 4% as per the net content of the silica; a content of lithium hydroxide is from 0.1% to 2% based on a total mass of the electrolyte solution.

Silica sol is a gel solution formed by uniformly diffusing the silica gel particles in water, and is represented by mSiO₂.n H₂O. The gel particles are nearly spherical and have a fine particle size (from 5 to 100 nm), a relatively large specific surface area and strong absorbability. In general, it is industrially prepared by using a sodium silicate solution (Na₂SiO₃.nH₂O or Na₂O.nH₂O) as a raw material, and subjecting the raw material to processes, e.g., acid neutralization, ion exchange, and then filtration, concentration, etc., which costs relatively less. Silica sol is a slightly milky white, transparent to translucent liquid with a low viscosity, good fluidity and facile potting. However, due to the influence of the preparation process of silica sol, the silica sol contains certain impurity ions, such as iron ions, magnesium ions and chloride ions. A battery assembled and potted by a gel electrolyte solution made of the silica sol alone is often low in initial capacity and liable to hydration and stratification of electrolyte, large in resistance, and other drawbacks.

The present inventors have studied and found that a compounded gelling agent prepared by compounding silica sol and precipitated silica can handle the problem resulting from use of mere silica sol.

Preferably, the present disclosure employs alkaline silica sol for compounding, and the alkaline silica sol is commercially available. Non-restrictively, the alkaline silica sol used in one specific embodiment of the present disclosure has a pH value (at 20 C) of 9.0 to 11.5, SiO₂% (by weight)=25 to 35%, a Na₂O content (by weight)≤0.5%, a viscosity (at 20° C.)≤10 mPa·s, and an average particle size of 8 to 20 nm. If the content of SiO₂ is too high, e.g., more than 40%, the viscosity of the silica sol itself will increase, which will adversely affect the fluidity of the electrolyte solution. If the content of SiO₂ is too low, a gel is easily to be formed after formation, but it is difficult to stably obtain a solidified electrolyte solution containing crystal particles. The particle size of silica in the silica sol has a great influence on the stability of the silica sol. Generally speaking, the repulsion potential energy between particles is proportional to the particle diameter. The larger the particle is, the better the stability is. The smaller the particle is, the faster the gelation rate is. If the particle size is less than 8 nm, the electrolyte solution system tends to be unstable. If the particle size exceeds 20 nm, the internal structure of the solidified electrolyte solution after formation may be too loose to facilitate ionic conduction.

The precipitated silica used in the present disclosure is white powder of hydrated amorphous silica and is a wet-process silicic acid product. The appearance of the precipitated silica is highly dispersed white amorphous powder and the major ingredient is silica. Primary particles of the precipitated silica are spherical, and the individual particles are in contact with each other to form a branched structure. The silicic acid molecular skeleton —Si—O—Si— in the form of sodium silicate is present inside the precipitated silica, while the condensation of such long molecules may render the arrangement between molecules very loose. Unlike the three-dimensional bulk structure dominated inside the fumed silica, the precipitated silica contains more irregular binary linear structures, so a capillary phenomenon occurs. The precipitated silica of the present disclosure is commercially available.

When the silica sol is used to formulate an electrolyte solution of a lead-acid storage battery, gel particles of the silica sol are negatively charged, so they adsorb H in the electrolyte solution after the addition of sulfuric acid, thereby causing charges of the gel dispersion system to be offset and its stability to be decreased, and it agglomerates to form a three-dimensional bulk network structure. After the addition of the precipitated silica, the two-dimensional linear precipitated silica particles optimize the three-dimensional bulk network structure formed by the silica gel to a certain extent. The present disclosure discovers that when the mass ratio of silica sol to precipitated silica is 1:(0.005 to 0.05), and a total content of the silica in the electrolyte solution is controlled within a range of 1% to 4% based on a total mass of the electrolyte solution, the solidified network structure formed after the formation is beneficial to the diffusion of SO₄²⁻ and H to the surface of the electrode, which can effectively reduce the internal resistance and make the reaction easier. If the addition amount of the precipitated silica is too large, agglomeration agglomerates easily, and the internal resistance of the electrolyte solution increases. If the addition amount of the precipitated silica is too small, the electrolyte solution is mainly gel after the formation, and it is quite difficult to obtain a solidified electrolyte solution containing crystal particles, which is disadvantageous for retarding the softening and shedding of the electrode plates.

A total content of the silica in the electrolyte solution according to the present disclosure means a net content of the silica, namely, a net amount of silica obtained by multiplying the amount of the silica sol by the content of SiO₂ in the silica sol plus the amount of the precipitated silica, and then dividing the net amount of silica by a total mass of the electrolyte solution to give the above content. The present disclosure discovers that the total content of the silica in the electrolyte solution places a decisive influence on the viscosity of the electrolyte solution and the physical form of the electrolyte solution after the formation. Specifically, if the total silica content is too low, the electrolyte solution is liable to hydration and stratification and the resistance is too large; and if the total silica content is too high, agglomeration agglomerates easily, which is not conducive to ion motion.

The electrolyte solution of the present disclosure further comprises 0.1% to 2% of lithium hydroxide. The present inventors have discovered that use of a specific combination of the gelling agents in the present disclosure in conjunction with lithium hydroxide having a relatively high content in the electrolyte solution contributes to the subsequent solidification of the electrolyte solution, and the addition of lithium hydroxide may play positive roles in adjusting the solidification velocity of the electrolyte solution and increasing the stability of the electrolyte solution.

The electrolyte solution of the present disclosure further comprises sulfuric acid having a density of 1.35 to 1.37 g/cm³ (at 25° C.) as an electrolyte, which is a main substance for transferring charges. The electrolyte solution of the present disclosure may still further comprise a small amount of inorganic, organic additives and the like. Examples of the inorganic additive of the present disclosure may include metal sulfates, metal oxides, etc. The addition of one or more metal sulfates in the electrolyte solution can significantly enhance the conductivity of the electrolyte solution, improve the capacity recovery capability of the battery, reduce sulfation of the electrode plates, and extend battery life. The organic additive of the present disclosure is, for example, polyacrylamide, polyvinyl alcohol, polyethylene glycol, fatty alcohol-polyoxyethylene ether, dextrin, glycerin or the like. The addition of polyacrylamide to the electrolyte can absorb the excess water precipitated from the solidified electrolyte solution due to shrinkage of the internal structure, thereby maintaining the uniformity of the entire system and maintaining the stability of the system. Polymeric surfactants such as polyvinyl alcohol and hydroxyethyl cellulose can form hydrogen bonds with silicon hydroxyl, reduce the aggregation between silica molecules, and can effectively reduce the water loss of the electrolyte solution during battery use, thereby increasing the cycle life of the lead-acid storage battery. In addition, the volume of a polymer is very large, which hinders the approaching of the silica molecules, and the silicon-oxygen bond is difficult to form. The addition of the polymeric surfactant can appropriately delay the gelation process and reduce the viscosity of the electrolyte solution, thereby facilitating the potting.

<Preparation Method of Electrolyte Solution>

The present disclosure further provides a method of preparing the electrolyte solution according to the present disclosure, comprising the steps of: adding silica sol and precipitated silica to a sulfuric acid solution, and stirring at 700 to 1500 r/min for 50 to 70 min. Non-restrictively, in one specific embodiment of the present disclosure, firstly, concentrated sulfuric acid is formulated into dilute sulfuric acid in advance and the dilute sulfuric acid is placed in a volumetric flask for use; and a desired amount of inorganic and organic additives such as lithium hydroxide is weighed. Next, a certain volume of a dilute sulfuric acid solution is measured and added in a dispersion tank, and the dispersion tank is fixed on a high-speed dispersion machine. The inorganic and organic additives are first uniformly mixed with dilute sulfuric acid at a low speed to obtain a sulfuric acid solution. Then, the formulated silica sol is added, uniformly mixed, and then precipitated silica is added in a calculated amount. Thereafter, the dispersion tank is covered with a lid and the rotation rate is adjusted to 700 to 1500 r/min for high-speed stirring, so that the system is sufficiently dispersed to obtain the electrolyte prepared by the present disclosure. An initial viscosity of the obtained electrolyte solution is from 50 to 350 mPa·s (at 25° C.).

<Lead-Crystal Storage Battery>

The present disclosure further provides a lead-crystal storage battery, comprising a battery container, an electrolyte solution according to the present disclosure, positive and negative electrode plates, and a separator.

As for the preparation method of the positive and negative electrode plates, please refer to the disclosure of the previous patent application CN106129369A of the present inventors.

The formation step of the present disclosure comprises the step of: placing the battery in a cooling pool for charging and discharging after the completion of the potting, wherein the water temperature for charging is maintained at 5 to 40° C. Charging includes the following two or three stages: in the first stage, charging with a current of 0.15 to 0.3 C for 2 to 5 h, then charging at a current of 0.1 to 0.2 C for 6 to 10 h, and next, charging at a current of 0.03 to 0.1 C for 4 to 6 h; in the second stage, continuously charging at a current of 0.15 to 0.25 C for 3 to 5 h, and then charging at a current of 0.05 to 0.15 C for 6 to 10 h: in the third stage, charging at a current of 0.15 to 0.25 C for 4 to 5 h, and then charging at a current of 0.05 to 0.15 C for 7 to 9 h. In the present disclosure, C is the nominal capacity of the battery. For example, the nominal capacity of the battery is 500 mAh, and 0.5 C means that the charging current is 250 mAh.

Unlike the gel electrolyte solution having amorphous silica as a major ingredient, which is formed after the formation of the battery such as a GEL-VRLA storage battery in the prior art, the electrolyte solution of the present disclosure is changed after the formation from a flow dynamic state to a solidified electrolyte solution containing crystal particles, which looks like a damp caking salt shape from the perspective of the appearance. The solidified electrolyte solution measured by X-ray diffraction has a characteristic peak of a crystal; specifically, it has a characteristic peak of a crystal in a range of diffraction angle of 20=28.00 0.20° measured by X-ray diffraction.

In order for further analysis of the crystal composition of the electrolyte solution, after the solidified electrolytic solution is dried at 105° C. for 5 to 6 h, it measured by X-ray diffraction has a sharp characteristic peak at a diffraction angle of 26.80±0.20°, and has characteristic peaks at diffraction angles of 21.00±0.20° and 50.00±0.20°, which are basically consistent with the characteristic peaks of α-quartz. Compared with ordinary gel, the solidified electrolytic solution containing crystal particles are capable of firmly fixing the active materials of the plates, delaying the softening and shedding of the plates, and improving the deep cycle capacity of the battery; the porous structure further provides enough space for ion motion, which can effectively reduce the resistance, improve the conductivity and oxygen compounding efficiency, increase the battery capacity, extend the service life of the battery, and improve the low temperature performance and charge retention.

Furthermore, the separator used for the lead-crystal storage battery of the present disclosure is preferably an AGM separator. The present disclosure combines the advantages of the AGM-VRLA storage battery and the GEL-VRLA storage battery. As the electrolyte solution of the present disclosure has a lower viscosity, it is more convenient for potting in comparison to the GEL-VRLA storage battery. Moreover, after the formation, the electrolyte solution becomes a solidified electrolyte solution containing crystal particles, and is more capable of firmly fixing the active materials of the plates and delaying the softening and shedding of the plates, in comparison to a GEL-VRLA storage battery. Additionally, although the present disclosure employs a starved-electrolyte design, an acid stratification phenomenon does not occur at the bottom of the battery, in that after the formation, the electrolyte solution becomes a solidified electrolyte solution containing crystal particles.

### EXAMPLES

Here are examples illustrating the present disclosure. It is understandable to one skilled in the art that the examples herein are merely exemplary, but not exhaustive.

### Test Method

Type of X-ray diffraction apparatus: ultima IV

Test method: 20 scanning range: 5-90°, fabric width: 0.2/min

Measurement of element content: ICP-OES inductive coupled plasma optical emission spectrometer

### Example 1

Formulation of electrolyte solution: Concentrated sulfuric acid was prepared into dilute sulfuric acid having a density of 1.35 g/ml, and it was placed in a volumetric flask for use; 200 parts of lithium hydroxide, 50 parts of sodium hydroxide, 50 parts of glycerol, 0.5 parts of cobalt sulfate, and 0.5 parts of polyacrylamide were weighed. Next, a given volume of a dilute sulfuric acid solution was measured and added in a dispersion tank and the dispersion tank was fixed on a high-speed dispersion machine. The above additives were firstly mixed uniformly with the dilute sulfuric acid at a low speed to obtain a sulfuric acid solution. Thereafter, 2500 parts of silica sol (having a SiO₂ content of 30% and an average particle size of 8 to 20 nm) was added, evenly mixed, and then 50 parts of precipitated silica was added. The mass ratio of the silica sol to the precipitated silica was 1:0.02. A total content of the silica in the electrolyte solution was 2 wt % as per the net content of the silica, and the electrolyte solution contained 0.5 wt % of lithium hydroxide based on the total mass of the electrolyte solution. After the addition was completed, the dispersion tank was covered with a lid and the rotating rate was adjusted to 900 r/min by stirring at a high speed for 60 min to give an electrolytic solution. An initial viscosity of the obtained electrolyte solution is 200 mPa·s (at 25° C.).

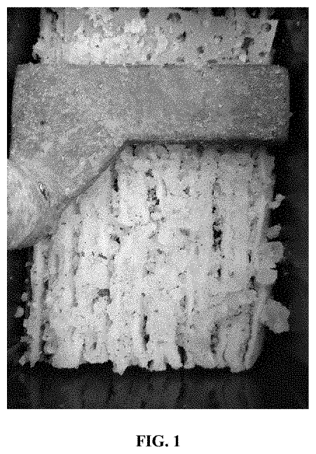

Preparation of lead-crystal storage battery, comprising the following steps: 1) preparation of positive and negative electrode plates: positive and negative lead pastes were applied to the positive and negative grids, wherein the positive lead paste included, in parts by mass, 100 parts of lead oxide powder, 10 parts of deionized water, 9 parts of sulfuric acid, 0.2 parts of graphite, and 0.1 part of polyester fiber; the negative lead paste included, in parts by mass, 100 parts of lead oxide powder, 9 parts of deionized water, 8 parts of sulfuric acid, 0.8 parts of barium sulfate, 0.25 parts of carbon black, 0.2 parts of sodium lignosulphonate, 0.3 parts of humic acid, and 0.15 parts of polyester fiber; the above-mentioned lead oxide powder had a particle size of 1 to 3 μm, in which 0.25% by mass of a mixture of antimony trioxide, stannous sulfate, magnesium sulfate and calcium sulfate with a particle size of 3 to 5 μm were mixed, and the length of the polyester fiber was 1 to 3 mm; 2) the cured and dried positive and negative electrode plates and an AGM separator were mounted to a battery case, and subsequently, the electrolyte solution prepared above was vacuum potted, and the degree of vacuum was −0.08 Mpa to −0.9 Mpa; 3) the battery was placed in a cooling pool for charging and discharging after the completion of the potting, wherein the water temperature for charging was maintained at 5 to 40° C. Charging included the following three stages: in the first stage, charging with a current of 0.25 C for 4 h, then charging at a current of 0.15 C for 6 h, and next, charging at a current of 0.1 C for 5 h; in the second stage, continuously charging at a current of 0.2 C for 4 h, and then charging at a current of 0.1 C for 10 h; in the third stage, charging at a current of 0.2 C for 4 h, and then charging at a current of 0.1 C for 10 h. Upon the completion of the formation, the battery was opened, and the electrolyte solution was found to be changed from a flow dynamic state to a solidified electrolyte solution containing crystal particles (see FIG. 1).

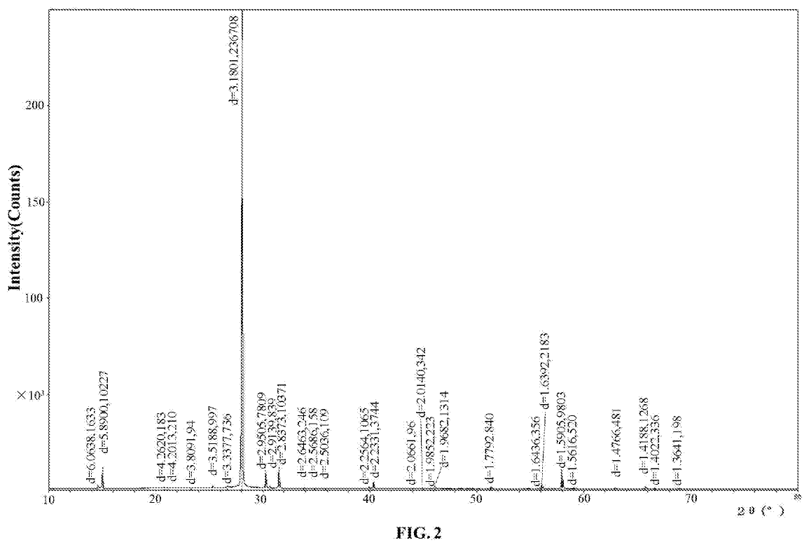

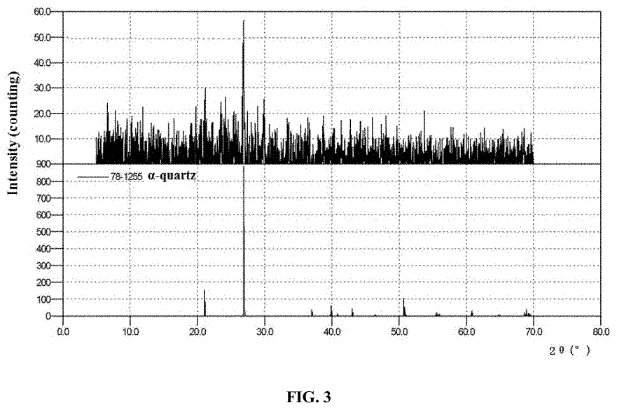

A small amount of the solidified electrolyte solution was measured for measurement by X-ray diffraction. The result was shown in FIG. 2. It has found that the electrolyte solution has a characteristic peak of crystal in the range of 20=28.000.20°, which demonstrates that the solidified electrolyte solution according to the present disclosure contains crystal particles. In order to further analyze the crystal composition thereof, after the solidified electrolyte solution was dried at 105° C. for 6 h, it measured by X-ray diffraction has a characteristic peak at a diffraction angle of 20=26.80 0.20° (see FIG. 3), which was basically consistent with the characteristic peak of α-quartz. This indicates that the solidified electrolyte solution according to the present disclosure contains a small amount of α-quartz crystal particles.

A small amount of the solidified electrolyte solution was measured for analysis of content of elements Si and Li. The results were listed in Table 1.

The resulting lead-crystal storage battery was tested for battery performance (see Table 2 for the details).

### Example 2

The addition amounts of precipitated silica and dilute sulfuric acid in Example 1 were changed, so that the mass ratio of the silica sol to the precipitated silica was 1:0.05. A total content of the silica in the electrolyte solution was 4 wt % as per the net content of the silica, and the electrolyte solution contained 0.9 wt % of lithium hydroxide based on the total mass of the electrolyte solution. After the formation performed in the same process as that in Example 1, it has found that the electrolyte solution was changed from a flow dynamic state to a solidified electrolyte solution containing crystal particles. The resulting lead-crystal storage battery was tested for batter performance.

### Comparative Example 1

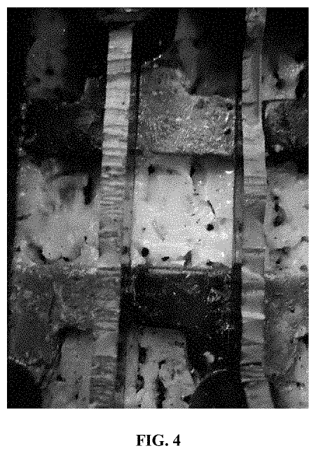

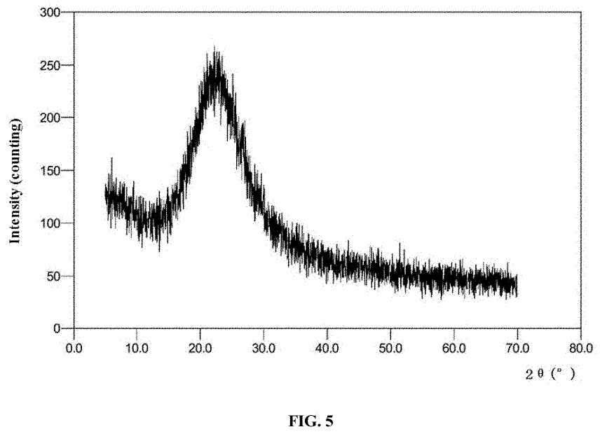

A commercially available GEL-VRLA gel battery prepared by using fumed silica as a gelling agent was selected for comparison. After the formation, the gel battery was opened to observe the physical state of the electrolyte solution (see FIG. 4). The electrolytic solution was found to be in a gel state. A small amount of gel electrolyte solution was dried at 105° C. for 6 h and then subjected to X-ray diffraction measurement. The results were shown in FIG. 5. It has found that a flat bread shaped peak, i.e., a peak shape of amorphous silica, appears at 2θ=15 to 30°.

A small amount of gel electrolyte solution was measured for analyses of content of elements Si and Li. The results were listed in Table 1. In spite of an approximate Si content, the gel electrolyte solution was devoid of element Li. This indicates that lithium hydroxide is not added to the electrolyte solution.

### Comparative Example 2

It was the same as Example 1, except for no addition of precipitated silica. The resulting lead-crystal storage battery was tested for batter performance.

### Comparative Example 3

It was the same as Example 1, except for no addition of silica sol. The resulting lead-crystal storage battery was tested for batter performance.

### Comparative Example 4

The addition amounts of lithium hydroxide and dilute sulfuric acid in Example 1 were changed, so that the electrolyte solution contained 3 wt % of lithium hydroxide, while the remaining was as same as that in Example 1. The resulting lead-crystal storage battery was tested for batter performance.

TABLE 1

| Test Items | Example 1 | Comparative Example 1 |
|---|---|---|
| Si (%) | 9.21 | 9.58 |
| Li (ppm) | 1524 | Undetected (detection |
| | | limit: 5 ppm) |

TABLE 2

| | | Examples | | Comparative Examples | | | |
|---|---|---|---|---|---|---|---|
| | | 1 | 2 | 1 | 2 | 3 | 4 |
| Silica sol | Addition | 2500 | 2500 | — | 2500 | 0 | 2500 |
| | amount | | | | | | |
| Precipitated | Addition | 50 | 125 | — | 0 | 50 | 50 |
| silica | amount | | | | | | |

| | | | | | | |
|---|---|---|---|---|---|---|
| Total content of silica in | 2 | 4 | — | 1.9 | 0.1 | 2 |
| electrolyte solution (wt %) | | | | | | |
| Percentage content of lithium | 0.5 | 0.9 | 0 | 0.5 | 0.5 | 3 |
| hydroxide | | | | | | |
| Physical state of electrolyte | Solidified | Solidified | Gel | Gel | Gel | Gel |
| solution after formation | state | state | | | | |
| | containing | containing | | | | |
| | crystal | crystal | | | | |
| | particles | particles | | | | |
| Test for low temperature | 50.3 | 45.6 | 30.5 | 38.6 | 38.2 | 36.7 |
| capacity of storage battery (a | | | | | | |
| percentage of the actual | | | | | | |
| capacity the discharging | | | | | | |
| capacity still reaches after the | | | | | | |
| storage battery is placed at −40° | | | | | | |
| C. and kept for 8 h, by %) | | | | | | |
| Capability to recover from | 92.3 | 90.4 | 70.4 | 73.3 | 72.6 | 75.2 |
| deep discharging of storage | | | | | | |
| battery (a percentage of the | | | | | | |
| rated capacity the capacity | | | | | | |
| still reaches after 30 times of | | | | | | |
| continuous charge-discharge | | | | | | |
| cycle when the storage battery | | | | | | |
| is discharged till the cut-off | | | | | | |
| voltage of the battery is 0 V, | | | | | | |
| and then completely | | | | | | |
| discharged, by %) | | | | | | |
| Charge retention (a | 81.3 | 75.6 | 63.2 | 72.1 | 70.8 | 74.4 |
| percentage of the rated | | | | | | |
| capacity the capacity still | | | | | | |
| reaches after the battery is | | | | | | |
| stored at a room temperature | | | | | | |
| of 20° C. for a year, by %) | | | | | | |

As can be appreciated from Table 2, the storage batteries prepared in Examples 1 and 2, which meet the requirements of the present disclosure, have high low temperature performance and high capability to recover from deep discharging, and high charge retention. Comparative Example 1 employs a commercially available GEL-VRLA gel battery that has fumed silica as a gelling agent; the silica content in the electrolyte solution is approximate that in Example 1 of the present disclosure, but lithium hydroxide is not added to the electrolyte solution, and the electrolyte solution after the formation is in a gel state, which causes its low temperature performance and capability to recover from deep discharging, and charge retention to be low. However, in Comparative Examples 2 and 3, in which only one gelling agent was used, or Comparative Example 4, in which a content of lithium hydroxide is too high, the electrolyte solutions after the formation are in a gel state, and also seriously affect capability to recover from deep discharging and low temperature capacity of the storage battery.

What is claimed is:

1. An electrolyte solution of a lead-crystal storage battery, wherein,
the electrolyte solution comprises sulfuric acid, a gelling agent and lithium hydroxide; the gelling agent comprises silica sol and precipitated silica in a mass ratio of 1:(0.005 to 0.05); a total content of the silica in the electrolyte solution is from 1% to 4% as per a net content of the silica; a content of lithium hydroxide is from 0.1% to 2% based on a total mass of the electrolyte solution; after completion of a formation step of the battery filled with the electrolyte solution, the electrolyte solution changes from a flow dynamic state to a solidified electrolyte solution containing crystal particles.

2. The electrolyte solution according to claim 1, wherein,
the solidified electrolyte solution measured by X-ray diffraction has a characteristic peak of crystal.

3. The electrolyte solution according to claim 1, wherein,
the silica sol contains SiO₂% (by weight)=28 to 35%; a particle size of the silica sol is from 8 to 15 nm.

4. The electrolyte solution according to claim 2, wherein,
the silica sol contains SiO₂% (by weight)=28 to 35%; an average particle size of the silica sol is from 8 to 15 nm.

5. The electrolyte solution according to claim 1, wherein,
the electrolyte solution comprises sulfuric acid having a density of from 1.35 to 1.37 g/cm³ (at 25° C.).

6. The electrolyte solution according to claim 2, wherein,
the electrolyte solution comprises sulfuric acid having a density of from 1.35 to 1.37 g/cm³ (at 25° C.).

7. The electrolyte solution according to claim 3, wherein,
the electrolyte solution comprises sulfuric acid having a density of from 1.35 to 1.37 g/cm³ (at 25° C.).

8. The electrolyte solution according to claim 1, wherein,
an initial viscosity of the electrolyte solution is from 50 to 350 mPa·s (at 25° C.).

9. The electrolyte solution according to claim 2, wherein,
an initial viscosity of the electrolyte solution is from 50 to 350 mPa·s (at 25° C.).

10. The electrolyte solution according to claim 1, wherein,
the solidified electrolyte solution is dried at 105° C., and has a characteristic peak at a diffraction angle of 2θ=26.80±0.20° when measured by X-ray diffraction.

11. The electrolyte solution according to claim 2, wherein,
the solidified electrolyte solution is dried at 105° C., and has a characteristic peak at a diffraction angle of 2θ=26.80±0.20° when measured by X-ray diffraction.

12. The electrolyte solution according to claim 1, wherein the solidified electrolyte solution contains α-quartz crystal.

13. The electrolyte solution according to claim 2, wherein the solidified electrolyte solution contains α-quartz crystal.

14. The electrolyte solution according to claim 1, wherein a charging current in the formation step is in a range of from 0.01 to 0.5 C.

15. The electrolyte solution according to claim 2, wherein a charging current in the formation step is in a range of from 0.01 to 0.5 C.

16. A method of preparing an electrolyte solution according to claim 1, comprising:
adding lithium hydroxide and other auxiliary materials to a sulfuric acid solution; and
adding silica sol and precipitated silica to the solution, and then stirring the solution at 700 to 1500 r/min for 50 to 70 min.

17. A method of preparing an electrolyte solution according to claim 2, comprising:
adding lithium hydroxide and other auxiliary materials to a sulfuric acid solution; and
adding silica sol and precipitated silica to the solution, and then stirring the solution at 700 to 1500 r/min for 50 to 70 min.

18. A lead-crystal storage battery, comprising:
a battery container,
an electrolyte solution according to claim 1,
positive and negative electrode plates, and
a separator.

19. The lead-crystal storage battery according to claim 18, wherein the separator is an AGM separator.

20. A lead-crystal storage battery, comprising:
a battery container,
an electrolyte solution prepared by the method according to claim 16,
positive and negative electrode plates, and
a separator.
